(19) United States
(12) Patent Application Publication
(10) Pub. No.: US 2025/0247757 A1
(43) Pub. Date: Jul. 31, 2025

(54) COMMUNICATION METHODS AND APPARATUSES, AND DEVICE, STORAGE MEDIUM, CHIP, PRODUCT AND PROGRAM

(71) Applicant: GUANGDONG OPPO MOBILE TELECOMMUNICATIONS CORP., LTD., Dongguan (CN)

(72) Inventors: Xin YOU, Dongguan (CN); Boren GUO, Dongguan (CN); Cong SHI, Dongguan (CN)

(73) Assignee: GUANGDONG OPPO MOBILE TELECOMMUNICATIONS CORP., LTD., Dongguan (CN)

(21) Appl. No.: 19/085,774

(22) Filed: Mar. 20, 2025

Related U.S. Application Data
(63) Continuation of application No. PCT/CN2022/120869, filed on Sep. 23, 2022.

(51) Int. Cl. H04W 36/08; H04L 41/16; H04W 36/00; H04W 36/32

(52) U.S. Cl. CPC H04W 36/08; H04L 41/16; H04W 36/0058; H04W 36/322; H04W 36/324

(57) ABSTRACT

A communication method, a terminal device and a network device are provided. The communication method includes that: a terminal device hands over from a source cell to a target cell, where the target cell is determined based on a target Artificial Intelligence (AI) model and target input information for input into the target AI model.

### CROSS-REFERENCE TO RELATED APPLICATION(S)

This application is a continuation of International Application No. PCT/CN2022/120869 filed on Sep. 23, 2022, the entire contents of which are hereby incorporated by reference in their entireties.

### RELATED ART

With the development of communication technologies, the current wireless communication system provides greater flexibility than in the past.

In current communication methods, taking cell handover as an example, it is generally determined whether to perform handover of the serving cell of the terminal device by determining whether the parameter value in an actual communication environment satisfies a threshold. However, such a method for determining whether to perform the handover of the serving cell of the terminal device cannot meet the handover requirements of the terminal device in complex communication scenarios.

### SUMMARY

Embodiments of the disclosure relate to the field of communication technologies, and provide a communication method, a terminal device and a network device.

In a first aspect, a communication method provided in an embodiment of the disclosure includes the following operation.

A terminal device hands over from a source cell to a target cell. The target cell is determined based on a target Artificial Intelligence (AI) model and target input information for input into the target AI model.

In a second aspect, a communication method provided in an embodiment of the disclosure includes the following operation.

A first network device performs handover of at least one terminal device from a source cell to a target cell. The target cell is determined based on a target AI model and target input information for input into the target AI model.

In a third aspect, a terminal device provided in an embodiment of the disclosure includes a processor and a memory.

The memory is configured to store a computer program that, when executed by the processor, causes the terminal device to hand over from a source cell to a target cell. The target cell is determined based on a target Artificial Intelligence (AI) model and target input information for input into the target AI model.

In a fourth aspect, a network device provided in an embodiment of the disclosure includes a processor and a memory.

The memory is configured to store a computer program that, when executed by the processor, causes the network device to perform handover of at least one terminal device from a source cell to a target cell. The target cell is determined based on a target AI model and target input information for input into the target AI model.

### BRIEF DESCRIPTION OF THE DRAWINGS

The accompanying drawings, which are illustrated herein, provide a further understanding of the disclosure and constitute a part of this disclosure. The exemplary embodiments of the disclosure and their description are used to explain the disclosure and not to unduly limit the disclosure. In the drawings:

FIG. 1 is a schematic diagram of an application scenario according to an embodiment of the disclosure.

FIG. 2 is a schematic diagram of a handover process provided in an embodiment of the disclosure.

FIG. 3 is a schematic flowchart of a communication method provided in an embodiment of the disclosure.

FIG. 4 is a schematic flowchart of another communication method provided in an embodiment of the disclosure.

FIG. 5 is a schematic flowchart of yet another communication method provided by an embodiment of the disclosure.

FIG. 6 is a schematic flowchart of still another communication method provided in an embodiment of the disclosure.

FIG. 7 is a schematic flowchart of a communication method provided in another embodiment of the disclosure.

FIG. 8 is a schematic flowchart of a communication method provided in yet another embodiment of the disclosure.

FIG. 9 is a schematic flowchart of a communication method provided in still another embodiment of the disclosure.

FIG. 10 is a schematic structural diagram of a communication apparatus provided in an embodiment of the disclosure.

FIG. 11 is a schematic structural diagram of another communication apparatus provided in an embodiment of the disclosure.

FIG. 12 is a schematic structural diagram of a communication device provided in an embodiment of the disclosure.

FIG. 13 is a schematic structural diagram of a chip according to an embodiment of the disclosure.

### DETAILED DESCRIPTION

The technical solutions in the embodiments of the disclosure would be described below in conjunction with the accompanying drawings in the embodiments of the disclosure. It is apparent that the described embodiments are a part of the embodiments of the disclosure, rather than all of the embodiments. Based on the embodiments of the disclosure, all other embodiments obtained by those of ordinary skill in the art without creative effort fall within the scope of protection of the disclosure.

The technical solutions described in embodiments of the disclosure may be combined in various ways without conflict. In the description of the disclosure, “a plurality of/multiple” means two or more unless otherwise explicitly and specifically defined.

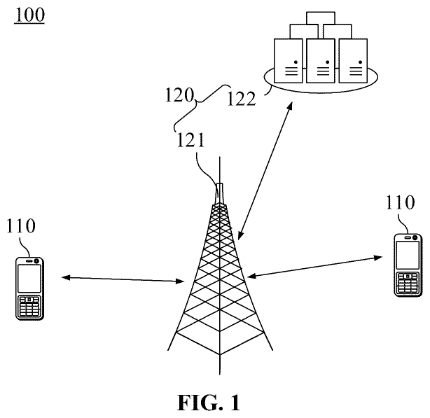

FIG. 1 is a schematic diagram of an application scenario according to an embodiment of the disclosure. As illustrated in FIG. 1, the communication system 100 may include a terminal 110 and a network device 120. The network device 120 may communicate with the terminal 110 through an air interface. Multi-service transmissions are supported between the terminal 110 and the network device 120.

It should be understood that the embodiments of the present disclosure are described only using the communication system 100 as an example, and the embodiments of the present disclosure are not limited thereto. That is, the technical solutions in the embodiments of the present disclosure can be applied to various communication systems, such as a Global System of Mobile communication (GSM) system, a Code Division Multiple Access (CDMA) system, a Wideband Code Division Multiple Access (WCDMA) system, a General Packet Radio Service (GPRS) system, a Long Term Evolution (LTE) system, an Advanced Long Term Evolution (LTE-A) system, a New Radio (NR) system, an evolution system of the NR system, a LTE-based access to unlicensed spectrum (LTE-U) system, a NR-based access to unlicensed spectrum (NR-U) system, a Universal Mobile Telecommunications System (UMTS), a Wireless Local Area Network (WLAN), a Wireless Fidelity (WiFi), an LTE Time Division Duplex (TDD), an Internet of Things (IoT) system, a Narrow Band Internet of Things (NB-IoT) system, an enhanced Machine-Type Communications (eMTC) system, or a future communication system (e.g., a sixth generation (6G) communication system, a seventh generation (7G) communication system), or the like.

The network device 120 in the embodiments of the disclosure may include an access network device 121 and/or a core network device 122. The access network device may provide communication coverage for a particular geographic area and may communicate with a terminal 110 (e.g., a UE) located within the coverage area.

The terminal in the disclosure is a device having a wireless communication function, which may be arranged on land including indoor or outdoor areas, handheld or on-board, or may be arranged on the water (such as on a ship), or may be arranged in the air (such as on an airplane, a balloon, or a satellite). The first terminal, the second terminal, the third terminal, the fourth terminal, or other terminals in the disclosure may be referred to as User Equipment (UE), a Mobile Station (MS), a Mobile Terminal (MT), a user unit, a user station, a mobile station, a remote station, a remote terminal, a mobile device, a user terminal, a terminal, a wireless communication device, a user agent or a user apparatus. The first terminal, the second terminal, the third terminal, the fourth terminal, or other terminal may include one or a combination of at least two of the following: an Internet of Things device, a satellite terminal, a Wireless Local Loop (WLL) station, a Personal Digital Processing (PDA) device, a handheld device having a wireless communication function, a computing device or other processing devices connected to a wireless modem, a server, a mobile phone, a tablet computer (or Pad), a computer with wireless transceiver function, a handheld computer, a desktop computer, a PDA, a portable media player, a smart speaker, a navigation apparatus, a wearable device (such as a smart watch, a smart glass, or a smart necklace), a pedometer, a digital TV, a Virtual Reality (VR) terminal device, an Augmented Reality (AR) terminal device, a wireless terminal device in industrial control, a wireless terminal device in self driving, a wireless terminal device in remote medical surgery, a wireless terminal device in a smart grid, a wireless terminal device in transportation safety, a wireless terminal device in a smart city, a wireless terminal device in a smart home, and a vehicle, an on-board device, an on-board module, a wireless modem, a handheld device, a Customer Premise Equipment (CPE), a smart home appliance or the like in a vehicle to everything (V2X) system.

Optionally, the terminal 110 may be any UE, which includes but is not limited to a terminal device in wired or wireless connection with the network device 120 or other terminal devices.

Optionally, the terminal device 110 may be used for a device to device (D2D) communication.

The access network device 121 may include one or a combination of at least two of the following: an Evolutional Node B (eNB or eNodeB) in the LTE system, a Next Generation Radio Access Network (NG RAN) device, a base station (gNB) in the NR system, a small station, a micro station, a radio controller in a Cloud Radio Access Network (CRAN), an access point of the Wi-Fi, a transmission reception point (TRP), a relay station, an access points, an on-board device, a wearable device, a hub, a switch, a bridge, a router, a network device in a future evolved Public Land Mobile Network (PLMN), and the like.

The core network device 122 may be a 5G core (5GC) device. The core network device 122 may include one or a combination of at least two of the following: an Access and Mobility Management Function (AMF), an Authentication Server Function (AUSF), a User Plane Function (UPF), or a Session Management Function (SMF), a Location Management Function (LMF) and a Policy Control Function (PCF). In other embodiments, the core network device may also be an Evolved Packet Core (EPC) device in the LTE network, for example, a Session Management Function+Core Packet Gateway (SMF+PGW-C) device. It should be understood that the SMF+PGW-C can achieve functions that can be achieved by the SMF and the PGW-C. In the process of the network evolution, the core network device 122 may also be referred to as other names, or may be a new network entity formed by dividing the functions of the core network, which would not be limited in the embodiments of the present disclosure.

Connections can be established between various functional units in the communication system 100 through Next Generation (NG) interfaces for achieving communication.

For example, the terminal device establishes air interface connection with the access network device through an NR interface for transmission of user plane data and control plane signaling. The terminal device may establish a control plane signaling connection with the AMF through an NG interface 1 (N1 for short). The access network device, such as a next generation radio access base station (gNB), may establish a user plane data connection with the UPF through an NG interface 3 (N3 for short). The access network device may establish a control plane signaling connection with the AMF through an NG interface 2 (N2 for short). The UPF may establish a control plane signaling connection with the SMF through an NG interface 4 (N4 for short). The UPF may interact user plane data with a data network through an NG interface 6 (N6 for short). The AMF may establish a control plane signaling connection with the SMF through an NG interface 11 (N11 for short). The SMF may establish a control plane signaling connection with the PCF through an NG interface 7 (N7 for short).

FIG. 1 exemplarily illustrates one base station, one core network device and two terminal devices. Optionally, the wireless communication system 100 may include multiple base station devices, and the respective number of terminal devices may be included within the coverage area of each of the base station devices, which would not be limited in embodiments of the present disclosure.

It should be noted that FIG. 1 only illustrates, by way of an example, the system to which the present disclosure is applied. Of course, the methods illustrated in the embodiments of the present disclosure may also be applied to other systems. In addition, the terms “system” and “network” in the present disclosure may usually be used interchangeably. In the disclosure, the term “and/or” refers to only an association relationship for describing associated objects and represents that three relationships may exist. For example, A and/or B may represent three cases: i.e., only A exists, both A and B exist, and only B exists. Furthermore, character “/” in the disclosure usually represents that previous and next associated objects form an “or” relationship. It should also be understood that the term “indication/indicate/indicating” mentioned in the embodiments of the disclosure may be a direct indication, or may be an indirect indication, or may represent existence of an association relationship. For example, A indicates B, which may represent that A directly indicates B, for example, B may be obtained by A; or may represent that A indirectly indicates B, for example, A indicates C, and B may be obtained by C; or may represent that an association relationship exists between A and B. It should also be understood that the term “corresponding/correspondence/correspond” mentioned in the embodiments of the present disclosure may indicate that there are direct or indirect correspondences between two objects, or may indicate that there is an association relationship between the two objects, or may have an indicating and being indicated relationship, a configuring and being configured relationship, or the like. It should also be understood that the terms “predefined/predefinition”, “predefined by a protocol”, “pre-determined/predetermination” or “predefined rules” mentioned in the embodiments of the present disclosure may be implemented by pre-storing corresponding codes or tables or by other means that may be used to indicate relevant information in devices (e.g., including terminal devices and network devices), specific implementations of which are not limited herein. For example, the “predefined” may refer to what is defined in protocol. It should also be understood that, in the embodiments of the present disclosure, the “protocol” may refer to standard protocols in the communication field, and may include, for example, an LTE protocol, an NR protocol and related protocols applied in future communication systems, which are not limited in the present disclosure.

For convenience of understanding of the technical solutions of the embodiments of the disclosure, related technologies in the embodiments of the disclosure are described. The following related technologies may be used as alternative solutions and may be combined with the technical solutions of the embodiments of the disclosure in various ways, all of which belong to the scope of protection of the embodiments of the disclosure.

When the terminal device using the network service moves from one cell to another cell, or due to the reasons such as a wireless transmission service load adjustment, an activation operation maintenance, a device failure, in order to ensure the continuity and the quality of service of the communication, the system transfers the communication link of the terminal device from the source cell to a new target cell, that is, executes a handover process.

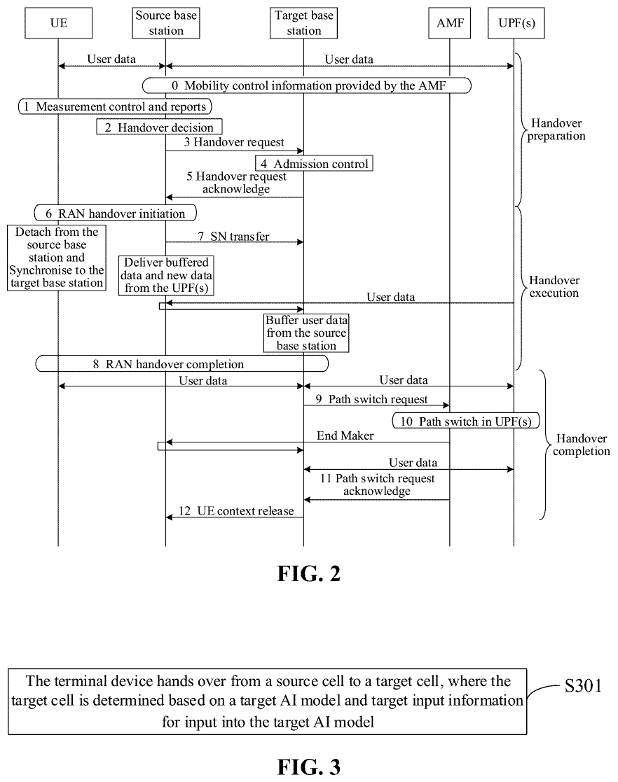

FIG. 2 is a schematic diagram of a handover process provided in an embodiment of the disclosure. As illustrated in FIG. 2, taking an Xn interface handover process as an example, the entire handover process can be divided into following three stages.
(1) Handover preparation: this includes measurement control and reports, handover request and acknowledge. The handover acknowledge message contains a handover command generated by the target cell, and the source cell is not allowed to make any modification to the handover command generated by the target cell, and directly forwards the handover command to the terminal device (also called “UE”).
(2) Handover execution: the terminal device immediately executes, after receiving the handover command, the handover process, i.e., the terminal device disconnects with the source cell and connects with the target cell (for example, the terminal device performs a random access, transmits Radio Resource Control (RRC) handover completion message to the target base station, etc.), Sequence Number (SN) status transfer, data forwarding.
(3) Handover completion: the target base station performs path switch with the Access and Mobility Management Function (AMF) and the User Port Function (UPF), and release the UE context of the source base station.

In FIG. 2, the handover process may include the following operations 1 to 12.

Before the operation 1, the terminal device interact user data with the source base station, and the source base station interact the user data with the UPF(s). Before the operation 1, an operation 0, i.e., providing mobility control information by AMF, may exist.

In any one of the embodiments of the disclosure, the source base station may be a base station corresponding to the source cell or a network device corresponding to the source cell, and the target base station may be a base station corresponding to the target cell or a network device corresponding to the target cell.

At the operation 1: measurement control and reports. The source base station performs measurement configuration on the terminal device, and a measurement result of the terminal device is used to assist the source base station in making handover decision. Then, the terminal device performs the measurement report based on the measurement configuration.

At the operation 2: handover decision. The source base station makes the handover decision according to its own handover algorithm by referencing to the result in the measurement report from the terminal device.

At the operation 3: the source base station transmits a handover request to the target base station. The source base station transmits a handover request message to the target base station, where the handover request message contains information related to the handover preparation which mainly includes X2 and SI signaling context references of the terminal device, a target cell identity, a key, a RRC context, an Access Stratum (AS) configuration, an Evolved Universal Terrestrial Radio Access Network Radio Access Bearer (E-UTRAN RAB, E-RAB) context, and the like. Moreover, the handover request message also contains source cell physical layer identity and a message authentication code, which are used for a recovery process after a possible handover failure. The X2 and S1 signaling context references of the terminal device may help the target base station find the location of the source base station. The E-RAB context includes necessary Radio Network Layer (RNL) and Transport Network Layer (TNL), addressing information, Quality of Service (QOS) information of the E-RAB, and the like. A part (e.g., the target cell identity) of the information related to the handover preparation is contained in the interface message itself, and another part (e.g., the RRC context) of the information related to the handover preparation exists in the RRC container of the interface message.

At the operation 4: admission control. The target base station performs admission control based on the received E-RAB QOS information to improve the success rate of the handover. It should be considered for the admission control reserving corresponding resources, Cell Radio Network Temporary Identity (C-RNTI) and allocating a dedicated random access preamble code. The AS configuration used by the target cell may be a complete configuration completely independent of the source cell, or an incremental configuration on the basis of the source cell (the incremental configuration means that the same parts are not configured, while only different parts are reconfigured through signaling, and the terminal device will continue to use the original configuration with respect to the configuration that is not received).

At the operation 5: the target base station transmits a handover request acknowledge to the source base station. The target base station performs the handover preparation, and transmits an Acknowledge (ACK) message for the handover request to the source base station at the same time. The ACK message contains an RRC container, the specific content of which is a handover command that triggers the terminal device to perform a handover. The source base station transmits the handover command to the terminal device via a transparent transmission (without any modification). The handover command contains a new C-RNTI, a case algorithm identifier of the target base station, and may also carry a random access dedicated preamble code, an access parameter, system information, and the like. If necessary, the ACK message for the handover request may also carry RNL/TNL information for data forwarding. Once the source base station receives the ACK message for the handover request or forwards the handover command to the terminal device, the data forwarding can be started.

At the operation 6: RAN handover initiation. The source base station transmits the handover command to the terminal device. The handover command (RRC connection reconfiguration message carrying mobility control information) is generated by the target base station and transparently transmitted to the terminal device via the source base station. Upon receiving the message, the terminal device will initiate the handover process by using relevant parameters in the message. The terminal device may initiate the handover process without waiting for the Hybrid Automatic Repeat reQuest (HARQ)/Automatic Repeat reQuest (ARQ) response transmitted by the lower layer to the source base station.

After the operation 6, the terminal device detaches from the source base station and synchronises to the target base station.

At the operation 7: the source base station performs SN transfer (may also be SN status transfer) to the target base station. The source base station transmits an SN status transfer message to the target base station, for conveying an uplink Packet Data Convergence Protocol (PDCP) SN reception status and a downlink PDCP SN transmission status for E-RABs (only those E-RABs that need to retain the PDCP status are required to perform SN status transfer, corresponding to a Radio Link Control (RLC) Acknowledged Mode (AM)).

After the operation 7, the source base station delivers buffered data and new data from the UPF. Then, the UPF may first transmit user data to be transmitted to the terminal device to the source base station, the source base station may then forward the user data to the target base station, and the target base station may buffer the user data from the source base station.

At the operation 8: RAN handover completion. After receiving the handover command, the terminal device performs synchronization with the target cell. If the random access dedicated preamble code is configured in the handover command, a contention free-based random access process is used to access the target cell; and if no dedicated preamble code is configured, a contention-based random access process is used to access the target cell.

After the operation 8, the terminal device will transmit user data to the UPF through the target base station.

At the operation 9: the target base station transmits a path switch request to the AMF. The target base station informs the AMF that the terminal device has switched the cell through the path switch request message. At this time, the handover of the air interface has been successfully completed.

At the operation 10: the path switch in the UPF(s) may be realized by following operations. The AMF transmits a user plane update request to the UPF, the UPF switches a downlink data path, and the UPF transmits a user plane update response to the AMF.

In order to assist with the reordering function at the target base station, the UPF immediately transmits one or more “End Marker packets” on the old path after the path switch. The “End Marker packet” contains no user data and is indicated by a GPRS Tunneling Protocol (GTP) header. After performing transmission of packets containing identifiers, the UPF should not transmit any packets on the old path. After receiving the “End Marker packet”, if forwarding is active for this bearer, the source base station should transmit the packet to the target base station. After detecting the “End Marker Packet”, the target base station should discard the “End Marker Packet” and initiate any necessary processes to maintain sequential delivery of the user data, so that user data is transmitted between the UPF and the target base station.

At the operation 11, the AMF transmits a path switch request acknowledge to the target base station, and the path switch process is completed.

At the operation 12, the target base station transmits a UE context release to the source base station, and the source base station receives the UE context release transmitted by the target base station and releases the UE context.

In conventional mobility management, the handover process is performed based on measurement reports from the terminal device and the decision made on the network side. The AI-based mobility management proposed in the disclosure can be used to select a more suitable target cell for the terminal device, thereby ensuring the continuity of services. For the AI mobility scenario, in order to ensure that the model works better, the embodiments of the disclosure provides the deployment of the model and the interaction of related information.

For convenience of understanding of the technical solutions of the embodiments of the disclosure, the technical solutions of the disclosure will be described in detail below with reference to specific embodiments. The above related technologies may be used as alternative solutions and may be combined with the technical solutions of the embodiments of the disclosure in various ways, all of which belong to the scope of protection of the embodiments of the disclosure. The embodiments of the disclosure include at least some of the following.

FIG. 3 is a schematic flowchart of a communication method provided in an embodiment of the disclosure. As illustrated in FIG. 3, the method includes the following operation S301.

At the operation S301, the terminal device hands over from a source cell to a target cell. The target cell is determined based on a target AI model and target input information for input into the target AI model.

Optionally, in any one of the embodiments of the disclosure, the AI model may also be referred to as a Machine Learning (ML) model, a neural network model or a neural network.

Optionally, the terminal device hands over from the source cell to the target cell, which may include that: the terminal device disconnects from the source cell and connects to the target cell.

Optionally, the target AI model may be a trained AI model. Alternatively, the target AI model may be further trained to obtain a more accurate model. Optionally, the target AI model may include an input layer, at least one intermediate layer, and an output layer. The target input information may be processed by the input layer, the at least one intermediate layer, and the output layer in sequence to obtain output cell information. Optionally, the output cell information may include at least one of: an output cell identity, output information of tracking area to which the cell belongs, or an output Public Land Mobile Network (PLMN) identity supported by the cell.

Optionally, the target input information is input into the target AI model, and a cell output by the target AI model may be a first cell, so as to determine the target cell based on the first cell.

Optionally, the target input information is input into the target AI model, and a cell output by the target AI model is a first cell, and the first cell may be determined as the target cell. In this way, the cell output by the target AI model is the target cell.

Alternatively, the target input information is input into the target AI model, and a cell output by the target AI model is a first cell, a second cell may be determined based on the first cell, and the second cell may be determined as the target cell.

In some embodiments, in a case that the target AI model is deployed in the terminal device, the target AI model of the terminal device may be pre-configured, or may be configured to the terminal device by a network device (e.g., a first network device or a network device other than the first network device). Optionally, the network device may configure weights and/or usage duration of the target AI model to the terminal device. In some embodiments, in a case that the target AI model is deployed in the first network device, the target AI model of the first network device may be pre-configured, or may be configured to the first network device by the terminal device, or may be configured by a core network device. Optionally, the terminal device or the core network device may configure the weights and/or the usage duration of the target AI model.

In the embodiment of the disclosure, the terminal device hands over from the source cell to the target cell. The target cell is determined based on the target AI model and the target input information for input into the target AI model. In this way, the target cell to which the terminal device hands over is not determined by means of whether the parameter value in the actual communication environment satisfies the threshold, but is determined based on the target AI model and the target input information for input into the target AI model, so that the AI technology and the communication system can be combined, which enables the present solution to be applicable in complex communication scenarios, thereby satisfying the handover requirements of the terminal device for the complex communication scenarios.

In some embodiments, the target AI model may be deployed in the terminal device, so that the output first cell may be determined based on the target AI model deployed within the terminal device and the target input information.

In some embodiments, the target input information includes: first input information and/or second input information.

The terminal device receives the first input information transmitted by the first network device corresponding to the source cell, and/or the terminal device determines the second input information of the terminal device.

The terminal device determines the target cell based on the target AI model, as well as the first input information and/or the second input information.

Optionally, the first input information may be input information obtained by the first network device, and the second input information may be input information obtained by the terminal device.

In any one of the embodiments of the disclosure, the first network device may be a network device corresponding to the source cell or a source network device, and a second network device may be a network device corresponding to the target cell or a target network device.

Exemplarily, the terminal device receives the first input information transmitted by the first network device corresponding to the source cell, and the terminal device determines the target cell based on the target AI model and the first input information.

Further exemplarily, the terminal device determines the second input information of the terminal device, and the terminal device determines the target cell based on the target AI model and the second input information.

Also exemplarily, the terminal device receives the first input information transmitted by the first network device corresponding to the source cell, and the terminal device determines the second input information of the terminal device. The terminal device determines the target cell based on the target AI model, the first input information and the second input information.

Optionally, the terminal device determines the second input information of the terminal device, which may include that: the terminal device obtains the second input information of the terminal device from the terminal device itself.

In some embodiments, the terminal device determines the target cell based on the target AI model, as well as the first input information and/or the second input information, which includes that: the terminal device determines a first cell based on the target AI model, as well as the first input information and/or the second input information, and the terminal device determines the target cell based on the first cell.

Exemplarily, the terminal device determines the first cell based on the target AI model and the first input information. Also exemplarily, the terminal device determines the first cell based on the target AI model and the second input information. Further exemplarily, the terminal device determines the first cell based on the target AI model, the first input information and the second input information.

Optionally, in some embodiments, the terminal device determines the target cell based on the first cell, which may include that: the terminal device determines the first cell as the target cell. Alternatively, in other embodiments, the terminal device determines the target cell based on the first cell, which may include that: the terminal device determines a second cell based on the first cell, and determines the second cell as the target cell.

In some embodiments, the target AI model may include a first AI model and a second AI model, the first AI model may be deployed in the first network device, and the second AI model may be deployed in the terminal device. Optionally, the first AI model may include an input layer, or may include an input layer and at least part of intermediate layers. Optionally, the second AI model may include an output layer, or may include an output layer and at least part of intermediate layers.

In some embodiments, the target input information includes first input information and/or second input information, the target AI model includes the first AI model and the second AI model, and the method further includes the following operations.

The terminal device receives first intermediate information transmitted by the first network device corresponding to the source cell. The first intermediate information is determined based on the first AI model, as well as the first input information and/or the second input information.

The terminal device determines a first cell based on the second AI model and the first intermediate information.

The terminal device determines the target cell based on the first cell.

Optionally, the first intermediate information may be information output by the first AI model after the target input information is input into the first AI model.

Optionally, the terminal device determines the first cell based on the second AI model and the first intermediate information, which includes that: the terminal device inputs the first intermediate information into the second AI model and outputs the first cell through the second AI model.

In some embodiments, when the first cell is determined, the terminal device may transmit the first cell to the first network device, to cause the first network device to determine whether to determine the first cell as the target cell, or to cause the first network device to determine that the target cell is the first cell or a second cell.

In some embodiments, the terminal device determines the target cell based on the first cell, which includes that: the terminal device transmits indication information to the first network device, where the indication information is used to indicate the first cell; and the terminal device receives a handover command transmitted by the first network device, where the handover command is used to indicate the target cell, where the target cell is the first cell or the second cell.

Optionally, each time the terminal device receives the first input information transmitted by the first network device corresponding to the source cell, the terminal device may determine the first cell once and transmit the indication information to the first network device. Alternatively, the terminal device may periodically determine the first cell and periodically transmit the indication information to the first network device. Optionally, the terminal device may determine a period for obtaining the first cell based on pre-configuration information, and/or determine a period for obtaining the first cell based on configuration information of the first network device.

In some embodiments, the indication information is carried in a measurement report. In other embodiments, the indication information may be carried in a message other than the measurement report.

In some embodiments, the terminal device determines the target cell based on the first cell, which includes that: the terminal device determines that the first cell is the target cell.

In other embodiments, the terminal device determines the target cell based on the first cell, which includes that: the terminal device determines the target cell based on the first cell and a measurement result.

Optionally, the terminal device may determine the target cell based on the measurement result measured by the terminal device and the first cell. Alternatively, the terminal device may determine the target cell based on the measurement result measured by the first network device (which is transmitted by the first network device) and the first cell. Optionally, the terminal device may determine the target cell based on the measurement result measured by the terminal device, the measurement result measured by the first network device, and the first cell.

Optionally, the terminal device may determine the target cell based on the first cell and the measurement result.

Exemplarily, the terminal device may determine whether the first cell satisfies a handover condition based on the measurement result. When the first cell satisfies the handover condition, the terminal device determines that the first cell is the target cell. When the first cell does not satisfy the handover condition, the terminal device determines the second cell satisfying the handover condition based on the measurement result, and determines the second cell as the target cell. Optionally, when it is determined based on the measurement result that no second cell satisfies the handover condition, the terminal device and the first network device do not perform the handover process.

Optionally, satisfying the handover condition may include satisfying one of: an A1 event, an A2 event, an A3 event, an A4 event, an A5 event, a B1 event, or a B2 event.

Optionally, the first cell satisfies the handover condition, which may include that: a measurement value of the source cell is less than or equal to a first threshold, and a measurement value of the first cell is greater than a second threshold. Optionally, the first cell does not satisfy the handover condition, which may include that: the measurement value of the first cell is less than or equal to the second threshold. Optionally, the first cell satisfies the handover condition, which may further include that: the number of beams whose measurement value is greater than the second threshold in the first cell is greater than a third threshold. Optionally, the first cell does not satisfy the handover condition, which may further include that: the number of beams whose measurement value is greater than the second threshold in the first cell is less than or equal to the third threshold.

Optionally, the measurement value may include at least one of: a Reference Signal Received Power (RSRP), a Reference Signal Received Quality (RSRQ), a Received Signal Strength Indicator (RSSI), or a Signal to Interference and Noise Ratio (SINR). Optionally, the thresholds corresponding to measurement values of different measurement parameters may be the same or different.

In some embodiments, the measurement result includes a measurement value of the first cell.

The terminal device determines the target cell based on the first cell and the measurement result, which includes that: when the measurement value of the first cell is greater than a preset threshold, the terminal device determines that the first cell is the target cell; and/or, when the measurement value of the first cell is less than or equal to the preset threshold value, the terminal device determines a cell whose measurement value is greater than the preset threshold in the measurement result as a second cell, and determines that the second cell is the target cell.

Optionally, when there are a plurality of cells whose measurement values are greater than the preset threshold in the measurement result, the terminal device may determine the cell corresponding to the maximum measurement value as the second cell, or the terminal device may determine the second cell from the plurality of cells based on location information and/or movement trajectory information of the terminal device.

In some embodiments, the target AI model may be deployed in the first network device.

In some embodiments, the target input information includes first input information and/or second input information, and the method further include the following operations.

The terminal device receives a handover command transmitted by the first network device corresponding to the source cell, where the handover command is used to indicate the target cell, and the target cell is the first cell or the second cell.

Herein, the first cell is determined based on the target AI model, as well as the first input information and/or the second input information.

The first input information is determined by the first network device.

The second input information is transmitted by the terminal device to the first network device.

Optionally, the terminal device may actively transmit the second input information to the first network device. Optionally, the terminal device may determine, based on pre-configuration information, the timing for transmitting the second input information to the first network device. Optionally, the terminal device may periodically or aperiodically transmit the second input information to the first network device. Optionally, the terminal device may transmit the second input information to the first network device every time the measurement report is obtained. Optionally, the terminal device may transmit the second input information to the first network device when the measurement request or the report request transmitted by the first network device is received.

Optionally, the handover command may carry indication information on the target cell, so that the terminal device may switch to the target cell based on the indication information on the target cell.

In some embodiments, the target AI model may include a third AI model and a fourth AI model, the third AI model may be deployed in the terminal device, and the fourth AI model may be deployed in the first network device. Optionally, the third AI model may include an input layer, or may include an input layer and at least part of intermediate layers. Optionally, the fourth AI model may include an output layer, or may include an output layer and at least part of intermediate layers.

In some embodiments, the target input information includes first input information and/or second input information, the target AI model includes the third AI model and the fourth AI model, and the method further includes the following operations.

The terminal device receives the first input information transmitted by the first network device corresponding to the source cell, and/or the terminal device determines the second input information of the terminal device.

The terminal device determines second intermediate information based on the third AI model, as well as the first input information and/or the second input information.

The terminal device transmits the second intermediate information to the first network device, where the second intermediate information is used to determine a first cell in conjunction with the fourth AI model.

The terminal device receives a handover command transmitted by the first network device, where the handover command is used to indicate the target cell, and the target cell is the first cell or a second cell.

Optionally, the second intermediate information may be information output by the third AI model after the target input information is input into the third AI model.

Optionally, in an embodiment, the second intermediate information is used to determine the first cell in conjunction with the fourth AI model, which may include that: the first network device determines the first cell based on the fourth AI model and the second intermediate information.

Optionally, in some embodiments, the first network device may directly determine the first cell as the target cell. Optionally, in other embodiments, the first network device may determine the target cell based on a measurement result and the first cell.

In some embodiments, the terminal device transmits the measurement result to the first network device, where the measurement result is used to determine the target cell in conjunction with the first cell.

Optionally, the measurement result transmitted by the terminal device to the first network device may be a measurement result measured by the terminal device.

In some embodiments, the method further includes that: the terminal device receives pre-configuration information transmitted by the first network device corresponding to the source cell, where the pre-configuration information includes at least one candidate cell, and the at least one candidate cell includes the target cell.

Optionally, the at least one candidate cell may be determined by the first network device based on a measurement report transmitted by the terminal device. Alternatively, the at least one candidate cell may be determined by the first network device based on measurement values obtained by measuring uplink signals of the terminal device by the first network device. Alternatively, the at least one candidate cell may be determined by the first network device based on the measurement report transmitted by the terminal device and the measurement values obtained by measuring the uplink signals of the terminal device by the first network device. Alternatively, the at least one candidate cell may be pre-configured in the first network device. Alternatively, the at least one candidate cell may be a neighboring cell of the source cell corresponding to the first network device.

In some embodiments, the first input information includes at least one of: cell information of the source cell, load information of the source cell, service type information supported by the source cell, or a measurement result of an uplink reference signal corresponding to the source cell.

In some embodiments, the second input information includes at least one of: a measurement result of the terminal device, location information of the terminal device, movement trajectory information of the terminal device, movement speed information of the terminal device, navigation information of the terminal device, or service requirement information of the terminal device.

Optionally, the cell information of the source cell may include at least one of:

location information of the first network device corresponding to the source cell, antenna angle information of the first network device corresponding to the source cell, cell radius information of the source cell, a cell identity of the source cell, information of a tracking area to which the source cell belongs, or a PLMN identifier supported by the source cell. Optionally, the cell information of the source cell may be used to determine whether the terminal device is within the coverage of the source cell, and/or whether the terminal device camps on the source cell within a preset duration, and/or whether the terminal device leaves the coverage of the source cell within the preset duration.

Optionally, the load information of the source cell may include at least one of: the maximum number of terminal devices supported by the source cell, the number of terminal devices in a connected state in the source cell, a maximum service amount supported by the source cell, or a current service amount of the source cell. Optionally, the service amount may include a bandwidth and/or an amount of data transmitted per unit time.

Optionally, the service type information may include at least the following services: a video service, a call service (including a network call service and/or a voice call service), a game service, a VR service, an AR service, a service corresponding to a Quality of Service (QOS) value (different QoS values correspond to different services), an IoT service, an enhanced Mobile BroadBand (eMBB) service, a massive Machine Type Communication (mMTC) service, an Ultra-Reliable and Low-Latency Communication (URLLC) service, a WiFi service, and/or a V2X service.

Optionally, the uplink reference signal may include at least one of: a Sounding Reference Signal (SRS), a DeModulation Reference Signal (DMRS), or a Phase Tracking Reference Signal (PTRS).

Optionally, in any of the embodiments of the disclosure, the measurement result may include one or more measurement values.

Optionally, the measurement result of the terminal device may include: a measurement result of the downlink reference signal measured by the terminal device. Optionally, the downlink reference signal may include at least one of: a Synchronization Signal Block (SSB) or a Channel State Information-Reference Signal (CSI-RS). Herein, the SSB may also be referred to as a Synchronization Signal/Physical Broadcast Channel Block (SS/PBCH block). The measurement result of the terminal device may include a cell measurement result and/or a beam measurement result.

Optionally, the location information of the terminal device may include at least one of: absolute location information of the terminal device, location information of the terminal device relative to the first network device, or a location identifier of the terminal device.

Optionally, at least one of the location information of the terminal device, the movement trajectory information of the terminal device, the movement speed information of the terminal device, or the navigation information of the terminal device may be used to predict a time when the terminal device leaves the source cell and/or a time when the terminal device enters the target cell.

Optionally, the service requirement information may include at least one of: video service requirement information, call service requirement information, game service requirement information, VR service requirement information, AR service requirement information, service requirement information corresponding to a QoS value, IoT service requirement information, eMBB service requirement information, mMTC service requirement information, URLLC service requirement information, or V2X service requirement information.

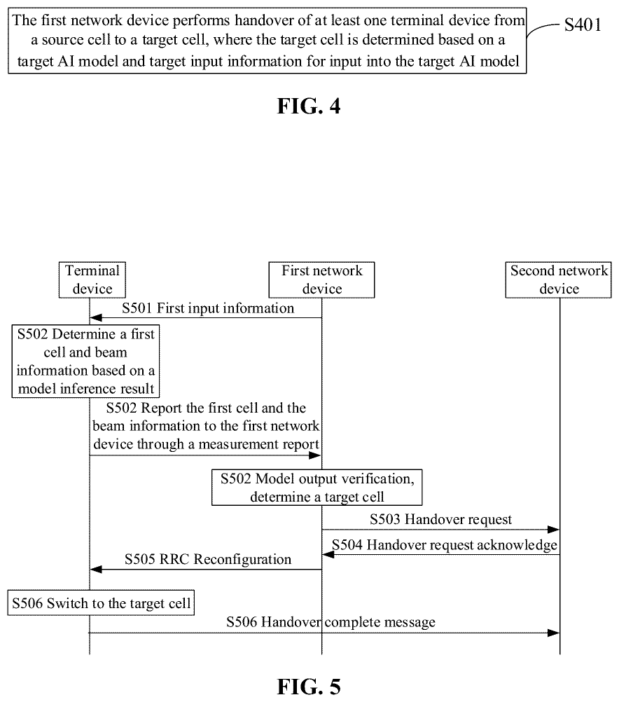

FIG. 4 is a schematic flowchart of another communication method provided in an embodiment of the disclosure, as illustrated in FIG. 4, the method includes the following operation S401.

At the operation S401, the first network device performs handover of at least one terminal device from a source cell to a target cell. The target cell is determined based on a target AI model and target input information for input into the target AI model.

Optionally, the first network device may perform handover of one terminal device from the source cell to the target cell. Optionally, the first network device may simultaneously perform handover of a plurality of terminal devices from the source cell(s) to the target cell(s).

Optionally, the target input information corresponding to one terminal device may be input into the target AI model, and the target cell corresponding to the one terminal device may be output through the target AI model.

Optionally, target input information corresponding to a plurality of terminal devices may be simultaneously input into the target AI model, thereby outputting target cell(s) corresponding to the plurality of terminal devices through the target AI model. In this way, the target cell(s) corresponding to the plurality of terminal devices are simultaneously obtained by the target AI model, so that the target cell(s) corresponding to the plurality of terminal devices can be reasonably determined. For example, if other conditions remain unchanged, when the current load information corresponding to the source cell is larger, a larger number of terminal devices can be switched to the target cell(s) through the target AI model, and/or when the current load information corresponding to the source cell is smaller, a smaller number of terminal devices can be switched to the target cell(s) through the target AI model.

Optionally, the first network device performs the handover of the terminal device from the source cell to the target cell, which may include at least one of: the first network device transmits a handover command to the terminal device, where the handover command is used to indicate the target cell; the first network device transmits a SN status to a second network device corresponding to the target cell; or the first network device forwards user data to the second network device.

In some embodiments, the target input information includes second input information, so that the terminal device may autonomously determine to input the second input information into the target AI model deployed in the terminal device, output a first cell through the target AI model deployed in the terminal device, and determine the target cell based on the first cell.

In some embodiments, the target input information includes first input information, or the target input information includes the first input information and the second input information, and the method further includes the following operation.

The first network device transmits the first input information to the terminal device, where the first input information is used to determine the target cell in conjunction with the target AI model, or the first input information is used to determine the target cell in conjunction with the target AI model and the second input information.

In this way, in one embodiment, the terminal device may input the first input information into the target AI model deployed in the terminal device, output the first cell through the target AI model deployed in the terminal device, and determine the target cell based on the first cell. In another embodiment, the terminal device may input the first input information and the second input information into the target AI model deployed in the terminal device, output the first cell through the target AI model deployed in the terminal device, and determine the target cell based on the first cell.

In some embodiments, the target input information includes the first input information and/or the second input information, the target AI model includes a first AI model and a second AI model, and the method further includes the following operations.

The first network device determines first intermediate information based on the first AI model, as well as the first input information and/or the second input information.

The first network device transmits the first intermediate information to the terminal device.

Herein, the first intermediate information is used to determine the target cell in conjunction with the second AI model.

In some embodiments, the method further includes the following operations.

The first network device receives indication information transmitted by the terminal device, where the indication information is used to indicate a first cell. Herein, the first cell is determined based on the target AI model, as well as the first input information and/or the second input information, or the first cell is determined based on the second AI model and the first intermediate information.

The first network device determines the target cell based on the first cell. Herein, the target cell is the first cell or a second cell.

The first network device performs the handover of the at least one terminal device from the source cell to the target cell, which includes that: the first network device transmits a handover command to the terminal device, where the handover command is used to indicate the target cell.

In some embodiments, the indication information is carried in a measurement report. In other embodiments, the indication information may be carried in a message other than the measurement report.

In some embodiments, the target input information includes the first input information and/or the second input information, and the method further includes the following operations.

The first network device determines the first input information of the first network device, and/or the first network device receives the second input information transmitted by the terminal device.

The first network device determines the target cell based on the target AI model, as well as the first input information and/or the second input information. Herein, the target cell is the first cell or the second cell.

The first network device performs the handover of the at least one terminal device from the source cell to the target cell, which includes that: the first network device transmits a handover command to the terminal device, where the handover command is used to indicate the target cell.

Optionally, the first network device determines the first input information of the first network device, which may include that: the first network device obtains the first input information of the first network device from the first network device itself.

Exemplarily, the first network device determines the first input information of the first network device, and the first network device determines the target cell based on the target AI model and the first input information.

Also exemplarily, the first network device receives the second input information transmitted by the terminal device, and the first network device determines the target cell based on the target AI model and the second input information.

Also exemplarily, the first network device determines the first input information of the first network device, the first network device receives the second input information transmitted by the terminal device, and the first network device determines the target cell based on the target AI model, the first input information and the second input information.

In some embodiments, the first network device determines the target cell based on the target AI model, as well as the first input information and/or the second input information, which includes that: the first network device determines the first cell based on the target AI model, as well as the first input information and/or the second input information; and the first network device determines the target cell based on the first cell.

In some embodiments, the first network device determines the target cell based on the target AI model, as well as the first input information and/or the second input information, which includes the following operations.

The first network device determines the first cell based on the target AI model, as well as the first input information and/or the second input information.

The first network device determines the target cell based on the first cell.

In some embodiments, the target input information includes the first input information and/or the second input information, the target AI model includes a third AI model and a fourth AI model, and the method further includes the following operations.

The first network device receives second intermediate information transmitted by the terminal device. Herein, the second intermediate information is determined based on the third AI model, as well as the first input information and/or the second input information.

The first network device determines the target cell based on the fourth AI model and the second intermediate information. Herein, the target cell is the first cell or the second cell.

The first network device performs the handover of the at least one terminal device from the source cell to the target cell, which includes that: the first network device transmits a handover command to the terminal device, where the handover command is used to indicate the target cell.

In some embodiments, the first network device determines the target cell based on the fourth AI model and the second intermediate information, which includes the following operations.

The first network device determines the first cell based on the fourth AI model and the second intermediate information.

The first network device determines the target cell based on the first cell.

In some embodiments, the first network device determines the target cell based on the first cell, which includes the following operation.

The first network device determines that the first cell is the target cell.

In some embodiments, the method further includes that: the first network device receives a measurement result transmitted by the terminal device. The first network device determines the target cell based on the first cell, which includes that: the first network device determines the target cell based on the first cell and the measurement result.

Optionally, the measurement result transmitted by the terminal device may be a measurement result of the terminal device.

Exemplarily, the first network device may determine whether the first cell satisfies a handover condition based on the measurement result. When the first cell satisfies the handover condition, the first network device determines that the first cell is the target cell. When the first cell does not satisfy the handover condition, the first network device determines the second cell satisfying the handover condition based on the measurement result, and determines the second cell as the target cell. Optionally, when it is determined based on the measurement result that there is no second cell satisfying the handover condition, the terminal device and the first network device do not perform the handover process.

In some embodiments, the measurement result includes a measurement value of the first cell.

The first network device determines the target cell based on the first cell and the measurement result, which includes that: when the measurement value of the first cell is greater than a preset threshold, the first network device determines that the first cell is the target cell; and/or when the measurement value of the first cell is less than or equal to the preset threshold value, the first network device determines a cell whose measurement value is greater than the preset threshold in the measurement result as a second cell, and determines that the second cell is the target cell.

Optionally, the preset threshold may be the same as the second threshold described above.

In some embodiments, the method further includes that: the first network device transmits pre-configuration information to the terminal device, where the pre-configuration information includes at least one candidate cell, and the at least one candidate cell includes the target cell.

In some embodiments, the first input information includes at least one of: cell information of the source cell, load information of the source cell, service type information supported by the source cell, or a measurement result of an uplink reference signal corresponding to the source cell.

In some embodiments, the second input information includes at least one of: a measurement result of the terminal device, location information of the terminal device, movement trajectory information of the terminal device, movement speed information of the terminal device, navigation information of the terminal device, or service requirement information of the terminal device.

The communication method of the embodiments of the disclosure will be described below from other aspects.

FIG. 5 is a schematic flowchart of yet another communication method provided by an embodiment of the disclosure. As illustrated in FIG. 5, in the embodiment corresponding to FIG. 5, the target AI model is deployed in the terminal device side, and the method includes the following operations S501 to S506.

At the operation S501, the first network device transmits first input information to the terminal device.

At the operation S502, the terminal device obtains second input information, the terminal device determines a first cell and beam information based on a model inference result and reports the first cell and the beam information to the first network device through the measurement report, and the first network device evaluates whether the first cell is suitable (i.e., model output verification), to determine the target cell.

Optionally, the terminal device may perform the model inference process based on the first input information, the second input information and the target AI model.

Optionally, the beam information may correspond to the first cell. Optionally, the beam information may be the beam measurement result in the above-described embodiment.

Optionally, when the first cell is suitable, the first cell is determined to be the target cell; when the first cell is not suitable, the second cell is determined as the target cell. Optionally, the second cell may be determined according to conventional handover decision algorithms. The second cell determined by the conventional handover decision algorithms may be a cell not determined by the target AI model. Exemplarily, the second cell may be determined by a method in a protocol prior to the disclosure.

At the operation S503, the first network device transmits a handover request to the second network device.

At the operation S504, the first network device receives a handover request acknowledge transmitted by the second network device.

At the operation S505, the first network device transmits RRC Reconfiguration to the terminal device.

Here, the RRC Reconfiguration may carry a handover command.

At the operation S506, the terminal device switches to the target cell, and transmits a handover complete message to the second network device.

Alternatively, the handover complete message may be referred to as RRC reconfiguration complete.

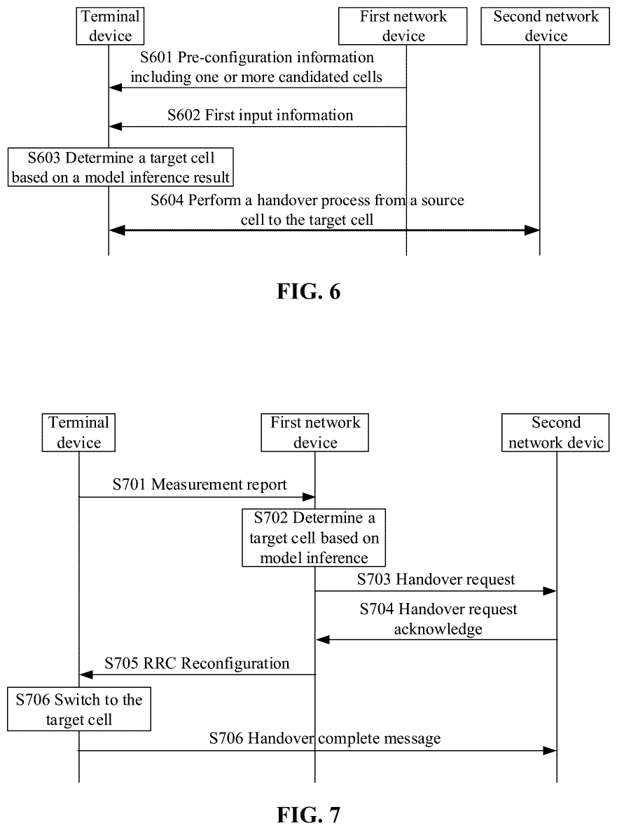

FIG. 6 is a schematic flowchart of still another communication method provided in an embodiment of the disclosure. As illustrated in FIG. 6, in the embodiment corresponding to FIG. 6, the target AI model is deployed in the terminal device side, and the method includes the following operations S601 to S604.

At the operation S601, the first network device transmits pre-configuration information to the terminal device, where the pre-configuration information may include one or more candidate cells.

At the operation S602, the first network device transmits first input information to the terminal device.

At the operation S603, the terminal device obtains second input information, and the terminal device determines the target cell based on a model inference result.

Optionally, in the implementation process, the terminal device may determine a first cell and beam information based on the model inference result, and the terminal device may evaluate whether the first cell is suitable (i.e., model output verification), to determine the target cell.

At the operation S604, the terminal device performs a handover process from the source cell to the target cell based on the pre-configuration information.

In the embodiment corresponding to FIG. 6, once the target cell is determined, the terminal device directly switches from the source cell to the target cell without the need for the first network device to transmit a handover command to the terminal device before performing the handover, thereby improving the handover efficiency.

FIG. 7 is a schematic flowchart of a communication method provided in another embodiment of the disclosure. As illustrated in FIG. 7, in the embodiment corresponding to FIG. 7, the target AI model is deployed in the network device side, and the method includes the following operations S701 to S706.

At the operation S701, the terminal device transmits a measurement report to the first network device.

Herein, the terminal device may measure the source cell and one or more candidate cells based on a measurement configuration, to obtain the measurement report.

In some embodiments, the terminal device may report the second input information to the first network device.

At the operation S702, the first network device determines the target cell based on a model inference.

Optionally, the first network device may determine a first cell through the model inference, and determine the target cell based on the first cell.

At the operation S703, the first network device transmits a handover request to the second network device.

At the operation S704, the first network device receives a handover request acknowledge transmitted by the second network device.

At the operation S705, the first network device transmits RRC reconfiguration to the terminal device.

At the operation S706, the terminal device switches to the target cell, and transmits a handover complete message to the second network device.

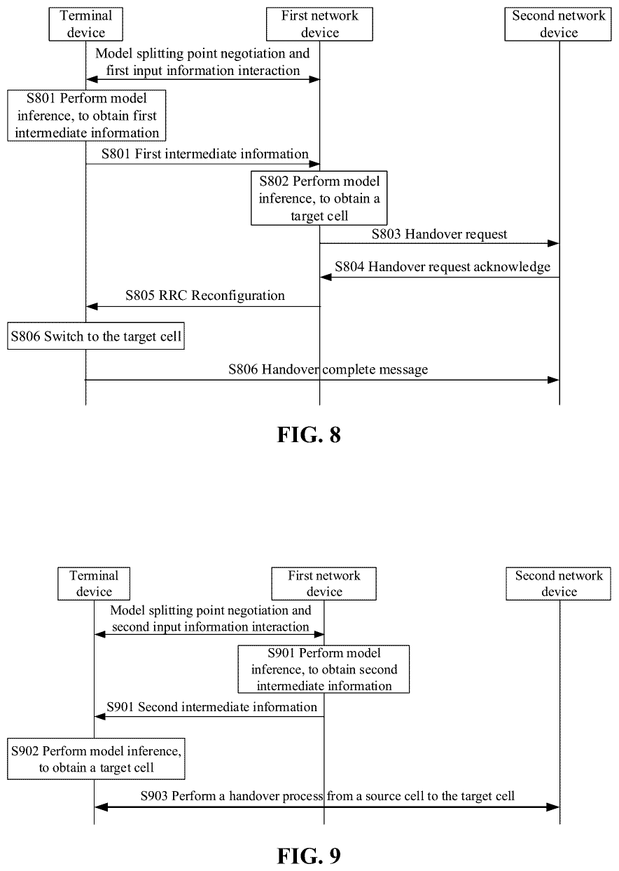

FIG. 8 is a schematic flowchart of a communication method provided in yet another embodiment of the disclosure. As illustrated in FIG. 8, in the embodiment corresponding to FIG. 8, the target AI model includes a first AI model and a second AI model, the first AI model is deployed in the first network device side, the second AI model is deployed in the terminal device side, and the method includes the following operations S801 to S806.

At the operation S801, the terminal device performs model inference, to obtain first intermediate information, and transmits the first intermediate information to the first network device.

Optionally, before the operation S801, the terminal device may negotiate a model splitting point with the first network device. In this way, the terminal device and the first network device may each deploy a part of the target AI model through the negotiated model splitting point. Before the operation S801, the terminal device may also receive the first input information transmitted by the first network device (i.e., interact with the first input information).

Optionally, the terminal device may negotiate the model splitting point with the first network device based on its own processing power.

Optionally, the terminal device may input the first input information and/or the second input information into the second AI model, and obtain the first intermediate information through the model inference.

At the operation S802, the first network device performs model inference to obtain the target cell.

Optionally, the first network device may input the first intermediate information into the first AI model, obtain a first cell through the model inference, and determine the target cell based on the first cell.

At the operation S803, the first network device transmits a handover request to the second network device.

At the operation S804, the first network device receives a handover request acknowledge transmitted by the second network device.

At the operation S805, the first network device transmits RRC reconfiguration to the terminal device.

At the operation S806, the terminal device switches to the target cell, and transmits a handover complete message to the second network device.

FIG. 9 is a schematic flowchart of a communication method provided in still another embodiment of the disclosure. As illustrated in FIG. 9, in the embodiment corresponding to FIG. 9, the target AI model includes a third AI model and a fourth AI model, the third AI model is deployed in the terminal device side, the fourth AI model is deployed in the first network device side, and the method includes the following operations S901 to S903.

At the operation S901, the first network device performs model inference to obtain second intermediate information, and transmits the second intermediate information to the terminal device.

Optionally, before the operation S901, the terminal device may negotiate a model splitting point with the first network device. In this way, the terminal device and the first network device can each deploy a part of the target AI model through the negotiated model splitting point. Before the operation S901, the terminal device may also transmit second input information to the first network device (i.e., interact with the second input information).

Optionally, the first network device may input the first input information and/or the second input information into the fourth AI model, and obtain the second intermediate information through the model inference.

At the operation S902, the terminal device performs model inference to obtain the target cell.

Optionally, the terminal device may input the second intermediate information into the third AI model, obtain a first cell through the model inference, and determine the target cell based on the first cell.

At the operation S903, the terminal device performs a handover process from the source cell to the target cell based on the pre-configuration information.

In the embodiments corresponding to FIGS. 8 and 9, by deploying part of the AI model in the terminal device, the processing power of the terminal device can be saved. In addition, in the embodiment corresponding to FIG. 8, the terminal device reports the first intermediate information to the first network device, thereby reducing the risk of information leakage, and avoiding the occurrence of a situation where the user is unwilling to provide information such as a historical trajectory to the first network device if the target AI model is deployed on the first network device side, resulting in inaccuracy in the determined first cell.

In some embodiments, the first network device may output the first cells of a plurality of terminal devices at a time through the deployed target AI model, the deployed first AI model, or the deployed fourth AI model, and the first cells of different terminal devices may be the same or different. Further, the first network device may determine whether each of the determined first cells is suitable, thereby determining target cell(s) of the plurality of terminal devices.

In some embodiments, both the value network and the policy network are deployed in the first network device. The policy network may be the target AI model in the embodiments of the disclosure. The value network is used to improve the policy network. In other embodiments, the policy network may be deployed on the terminal device side and the value network may be deployed on the first network device side, or both the value network and the policy network may be deployed on the terminal device side.

The embodiments of the disclosure propose flowcharts of the model deployment and interaction, including a scenario in which the model is deployed on the terminal side, on the network side, or on both sides, thereby ensuring the use of the AI mobility model, and further ensuring the success rate of the handover.

Preferred embodiments of the present disclosure have been described in detail with reference to the accompanying drawings, but the present disclosure is not limited to the specific details of the above embodiments. Within the scope of the technical conception of the present disclosure, various simple modifications can be made to the technical solutions of the present disclosure, and these simple modifications all fall within the scope of protection of the present disclosure. For example, various specific technical features described in the above specific embodiments may be combined in any suitable manner without conflict. Various possible combinations are not further described in the present disclosure to avoid unnecessary repetition. For another example, various different implementations of the present disclosure can also be combined arbitrarily, which should also be considered as the content disclosed by the present disclosure as long as they do not violate the conception of the present disclosure. For another example, various embodiments described in the present disclosure and/or the technical features in various embodiments can be arbitrarily combined with the related technologies without conflict, and the technical solution obtained after the combination should also fall within the scope of protection of the present disclosure.

It should also be understood that in the various method embodiments of the present disclosure, the size of the serial numbers of the above-mentioned various processes do not indicate a sequence of execution. The sequence of execution of the processes should be determined by their functions and inherent logics, and should not constitute a limitation on the implementation process of the embodiments of the present disclosure. Further, in embodiments of the present disclosure, the terms “downlink”, “uplink” and “sidelink” are used to indicate transmission directions of signals or data. The term “downlink” is used to denote that the transmission direction of the signals or the data is a first direction from a station to user equipment in a cell. The term “uplink” is used to denote that the transmission direction of the signals or the data is a second direction from the user equipment in the cell to the station. The term “sidelink” is used to denote that the transmission direction of the signals or the data is a third direction from first user equipment to second user equipment. For example, “downlink signal” means that the transmission direction of the signal is the first direction. In addition, in the embodiments of the present disclosure, the term “and/or” refers to only an association relationship for describing associated objects and represents that three relationships may exist. Specifically, A and/or B may represent three cases: i.e., only A exists, both A and B exist, and only B exists. Furthermore, character “/” in the disclosure usually represents that previous and next associated objects form an “or” relationship.

FIG. 10 is a schematic structural diagram of a communication apparatus provided in an embodiment of the disclosure, which is applied to a terminal device. As illustrated in FIG. 10, the communication apparatus 1000 includes a communication unit 1001.

The communication unit 1001 is configured to hand over from a source cell to a target cell. The target cell is determined based on a target AI model and target input information for input into the target AI model.

In some embodiments, the communication apparatus 1000 further includes a determination unit 1002, configured to determine the target cell.

In some embodiments, the target input information includes first input information and/or second input information.

The communication unit 1001 is configured to receive the first input information transmitted by a first network device corresponding to the source cell, and/or the determination unit 1002 is further configured to determine the second input information of the terminal device.

The determination unit 1002 is further configured to determine the target cell based on the target AI model, and the first input information and/or the second input information.

In some embodiments, the determination unit 1002 is further configured to determine a first cell based on the target AI model, and the first input information and/or the second input information; and determine the target cell based on the first cell.

In some embodiments, the target input information includes first input information and/or second input information, the target AI model includes a first AI model and a second AI model, and the communication unit 1001 is further configured to receive first intermediate information transmitted by a first network device corresponding to the source cell, where the first intermediate information is determined based on the first AI model, and the first input information and/or the second input information.

The determination unit 1002 is further configured to determine a first cell based on the second AI model and the first intermediate information, and determine the target cell based on the first cell.

In some embodiments, the communication unit 1001 is further configured to: transmits indication information to the first network device, where the indication information is used to indicate the first cell; and receive a handover command transmitted by the first network device, where the handover command is used to indicate the target cell, and the target cell is the first cell or a second cell.

In some embodiments, the indication information is carried in a measurement report.

In some embodiments, the determination unit 1002 is further configured to determine that the first cell is the target cell. Alternatively, the determination unit 1002 is further configured to determine the target cell based on the first cell and a measurement result.

In some embodiments, the measurement result includes a measurement value of the first cell. The determination unit 1002 is further configured to: in a case that the measurement value of the first cell is greater than a preset threshold, determine that the first cell is the target cell; and/or, in a case that the measurement value of the first cell is less than or equal to the preset threshold, determine a cell whose measurement value is greater than the preset threshold in the measurement result as a second cell, and determine that the second cell is the target cell.

In some embodiments, the target input information includes first input information and/or second input information. The communication unit 1001 is further configured to receive a handover command transmitted by a first network device corresponding to the source cell, where the handover command is used to indicate the target cell, and the target cell is a first cell or a second cell.

Herein, the first cell is determined based on the target AI model, and the first input information and/or the second input information, the first input information is determined by the first network device, and the second input information is transmitted by the terminal device to the first network device.

In some embodiments, the target input information includes first input information and/or second input information, the target AI model includes a third AI model and a fourth AI model, and the communication unit 1001 is further configured to receive the first input information transmitted by a first network device corresponding to the source cell, and/or the determination unit 1002 is further configured to determine the second input information of the terminal device. The determination unit 1002 is further configured to determine second intermediate information based on the third AI model, and the first input information and/or the second input information. The communication unit 1001 is further configured to transmit the second intermediate information to the first network device, where the second intermediate information is used to determine a first cell in conjunction with the fourth AI model, and receive a handover command transmitted by the first network device, where the handover command is used to indicate the target cell, and the target cell is the first cell or a second cell.

In some embodiments, the communication unit 1001 is further configured to transmit a measurement result to the first network device, where the measurement result is used to determine the target cell in conjunction with the first cell.

In some embodiments, the communication unit 1001 is further configured to receive pre-configuration information transmitted by a first network device corresponding to the source cell, where the pre-configuration information includes at least one candidate cell, and the at least one candidate cell includes the target cell.

In some embodiments, the first input information includes at least one of: cell information of the source cell, load information of the source cell, service type information supported by the source cell, or a measurement result of an uplink reference signal corresponding to the source cell.

The second input information includes at least one of: a measurement result of the terminal device, location information of the terminal device, movement trajectory information of the terminal device, movement speed information of the terminal device, navigation information of the terminal device, or service requirement information of the terminal device.

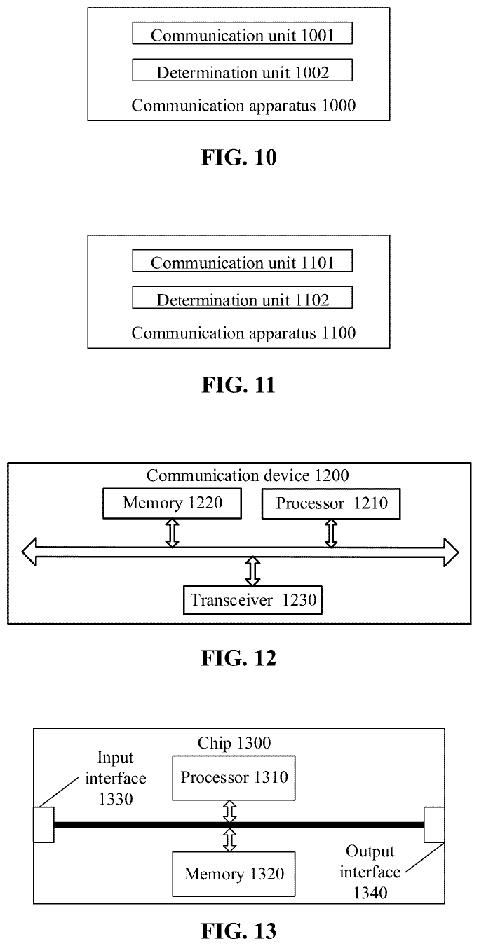

FIG. 11 is a schematic structural diagram of another communication apparatus provided in an embodiment of the disclosure, which is applied to a first network device. As illustrated in FIG. 11, the communication device 1100 includes a communication unit 1101.

The communication unit 1101 is configured to perform handover of at least one terminal device from a source cell to a target cell, where the target cell is determined based on a target AI model and target input information for input into the target AI model.

In some embodiments, the communication apparatus 1101 further includes a determination unit 1102 configured to determine the target cell.

In some embodiments, the target input information includes first input information, or the target input information includes the first input information and second input information. The communication unit 1101 is further configured to transmit the first input information to the terminal device, where the first input information is used to determine the target cell in conjunction with the target AI model, or the first input information is used to determine the target cell in conjunction with the target AI model and the second input information.

In some embodiments, the target input information includes first input information and/or second input information, and the target AI model includes a first AI model and a second AI model. The determination unit 1102 is further configured to determine first intermediate information based on the first AI model, and the first input information and/or the second input information. The communication unit 1101 is further configured to transmit the first intermediate information to the terminal device. Herein, the first intermediate information is used to determine the target cell in conjunction with the second AI model.

In some embodiments, the communication unit 1101 is further configured to receive indication information transmitted by the terminal device, where the indication information is used to indicate a first cell, and where the first cell is determined based on the target AI model, and the first input information and/or the second input information, or the first cell is determined based on the second AI model and the first intermediate information. The determination unit 1102 is further configured to determine the target cell based on the first cell, where the target cell is the first cell or a second cell. The communication unit 1101 is further configured to transmit a handover command to the terminal device, where the handover command is used to indicate the target cell.

In some embodiments, the indication information is carried in a measurement report.

In some embodiments, the target input information includes first input information and/or second input information.

In some embodiments, the determination unit 1102 is further configured to determine the first input information of the first network device, and/or the communication unit 1101 is further configured to receive the second input information transmitted by the terminal device. The determination unit 1102 is further configured to determine the target cell based on the target AI model, and the first input information and/or the second input information, where the target cell is a first cell or a second cell. The communication unit 1101 is further configured to transmit a handover command to the terminal device, where the handover command is used to indicate the target cell.

In some embodiments, the determination unit 1102 is further configured to determine the first cell based on the target AI model, and the first input information and/or the second input information; and determine the target cell based on the first cell.

In some embodiments, the target input information includes first input information and/or second input information, and the target AI model includes a third AI model and a fourth AI model. The communication unit 1101 is further configured to receive second intermediate information transmitted by the terminal device, where the second intermediate information is determined based on the third AI model, and the first input information and/or the second input information. The determination unit 1102 is further configured to determine the target cell based on the fourth AI model and the second intermediate information, where the target cell is a first cell or a second cell. The communication unit 1101 is further configured to transmit a handover command to the terminal device, where the handover command is used to indicate the target cell.

In some embodiments, the determination unit 1102 is further configured to determine the first cell based on the fourth AI model and the second intermediate information, and determine the target cell based on the first cell.

In some embodiments, the determination unit 1102 is further configured to determine that the first cell is the target cell.

In some embodiments, the communication unit 1101 is further configured to receive a measurement result transmitted by the terminal device. The determination unit 1102 is further configured to determine the target cell based on the first cell and the measurement result.

In some embodiments, the measurement result includes a measurement value of the first cell. The determination unit 1102 is further configured to: in a case that the measurement value of the first cell is greater than a preset threshold, determine that the first cell is the target cell; and/or, in a case that the measurement value of the first cell is less than or equal to the preset threshold, determine a cell whose measurement value is greater than the preset threshold in the measurement result as the second cell, and determine that the second cell is the target cell.

In some embodiments, the communication unit 1101 is further configured to transmit pre-configuration information to the terminal device, where the pre-configuration information includes at least one candidate cell, and the at least one candidate cell includes the target cell.

In some embodiments, the first input information includes at least one of: cell information of the source cell, load information of the source cell, service type information supported by the source cell, or a measurement result of an uplink reference signal corresponding to the source cell.

The second input information includes at least one of: a measurement result of the terminal device, location information of the terminal device, movement trajectory information of the terminal device, movement speed information of the terminal device, navigation information of the terminal device, or service requirement information of the terminal device.

Those skilled in the art would appreciate that the relevant description of the above communication apparatuses according to the embodiments of the present disclosure may be understood with reference to the relevant description of the communication methods according to the embodiments of the present disclosure.

FIG. 12 is a schematic structural diagram of a communication device provided in an embodiment of the disclosure. The communication device 1200 may include one of a terminal device or a first network device. The communication device 1200 illustrated in FIG. 12 may include a processor 1210 and a memory 1220. The memory 1220 stores a computer program executable on the processor 1210. The processor 1210 performs the communication method in any one of the above embodiments when executes the program.

Optionally, the memory 1220 may be a separate device independent of the processor 1210 or may be integrated in the processor 1210.

In some embodiments, as illustrated in FIG. 12, the communication device 1200 may further include a transceiver 1230, and the processor 1210 may control the transceiver 1230 to communicate with other devices. Specifically, the processor 1210 may control the transceiver 1230 to transmit information or data to other devices, or receive information or data from other devices.

The transceiver 1230 may include a transmitter and a receiver. The transceiver 1230 may further include one or more antennas.

In some embodiments, the communication device 1200 may specifically be the terminal device/the first network device in the embodiments of the present disclosure, and the communication device 1200 may implement corresponding processes implemented by the terminal device/the first network device in various methods of the embodiments of the present disclosure, which are not elaborated here for the sake of brevity.

An embodiment of the disclosure also provides a computer storage medium having stored thereon one or more programs that, when executed by one or more processors, cause the one or more processors to perform the communication method in any one of the embodiments of the disclosure.

In some embodiments, the computer-readable storage medium may be applied to the terminal device or the first network device in the embodiments of the disclosure, and the computer program causes the computer to execute corresponding processes implemented by the terminal device or the first network device in various methods of the embodiments of the present disclosure, which are not elaborated here for the sake of brevity.

FIG. 13 is a schematic structural diagram of a chip according to an embodiment of the disclosure. The chip 1300 illustrated in FIG. 13 includes a processor 1310 configured to invoke and run a computer program from a memory to implement the methods in the embodiments of the present disclosure.

In some embodiments, as illustrated in FIG. 13, the chip 1300 may further include a memory 1320, and the processor 1310 may invoke and run a computer program from the memory 1320 to implement the methods in the embodiments of the present disclosure.

The memory 1320 may be a separate device independent of the processor 1310, or may be integrated in the processor 1310.

In some embodiments, the chip 1300 may further include an input interface 1330. The processor 1310 may control the input interface 1330 to communicate with other devices or chips. Specifically, the processor 1310 may control the input interface 1330 to acquire information or data transmitted by other devices or chips.

In some embodiments, the chip 1300 may further include an output interface 1340. The processor 1310 may control the output interface 1340 to communicate with other devices or chips. Specifically, the processor 1310 may control the output interface 1340 to output information or data to other devices or chips.

In some embodiments, the chip may be applied to the terminal device/the first network device in the embodiments of the present disclosure, and the chip may implement corresponding processes implemented by the terminal device/the first network device in various methods of the embodiments of the present disclosure, which are not elaborated here for the sake of brevity.

It should be understood that the chip mentioned in the embodiments of the present disclosure may also be referred to as a system-level chip, a system chip, a chip system, or a system-on-chip chip, or the like.

An embodiment of the disclosure further provides a computer program product including a computer storage medium. The computer storage medium stores a computer program including instructions executable by at least one processor that, when executed by the at least one processor, implement the communication method in any one of the embodiments of the disclosure.

In some embodiments, the computer program product may be applied to the terminal device or the first network device in the embodiments of the disclosure, and the computer program instructions cause the computer to execute corresponding processes implemented by the terminal device or the first network device in various methods of the embodiments of the present disclosure, which are not elaborated here for the sake of brevity.

Optionally, the computer program product in the embodiment of the disclosure may also be referred to as a software product in other embodiments.

An embodiment of the disclosure further provides a computer program that causes a computer to execute the communication method in any one of the embodiments of the disclosure.

In some embodiments, the computer program may be applied to the terminal device or the first network device in the embodiments of the disclosure, and the computer program causes a computer to execute corresponding processes implemented by the terminal device or the first network device in various methods of the embodiments of the present disclosure when the computer program is run on the computer, which are not elaborated here for the sake of brevity.

The processor, the communication apparatus or the chip in the embodiments of the disclosure may be an integrated circuit chip having signal processing capability. In implementation, the various operations of the above method embodiments may be accomplished by integrated logic circuit of hardware or instructions in the form of software in a processor. The processor, the communication apparatus, or the chip described above may include an integration of any one or more of: a general purpose processor, an Application Specific Integrated Circuit (ASIC), a Digital Signal Processor (DSP), a Digital Signal Processing Device (DSPD), a Programmable Logic Device (PLD), a Field Programmable Gate Array (FPGA), a Central Processing Unit (CPU), a Graphics Processing Unit (GPU), an embedded neural-network processing unit (NPU), a controller, a microcontroller, a microprocessor, a programmable logic device, a discrete gate or transistor logic device, a discrete hardware component. The methods, operations and logic block diagrams disclosed in embodiments of the present disclosure may be implemented or performed. The general purpose processor may be a microprocessor or the processor may be any conventional processor or the like. The operations of the methods disclosed in combination with the embodiments of the present disclosure can be directly embodied as execution of a hardware decoding processor or combined execution of hardware and software modules in the decoding processor. The software module may be located in a Random-Access Memory (RAM), a flash memory, a Read-Only Memory (ROM), a Programmable ROM (PROM) or an Electrically Erasable EPROM (EEPROM), a register and other storage medium mature in the art. The storage medium is located in the memory, and the processor reads information in the memory and completes the operations of the above methods in combination with its hardware.

It is understood that the memory or the computer storage medium in embodiments of the present disclosure may be volatile memory or non-volatile memory or may include both volatile and non-volatile memory. The non-volatile memory may be an ROM, a PROM, an Erasable PROM (EPROM), an EEPROM, or a flash memory. The volatile memory may be an RAM which serves as an external cache. By way of illustration but not limitation, many forms of RAMs are available, such as a Static RAM (SRAM), a Dynamic RAM (DRAM), a Synchronous DRAM (SDRAM), a Double Data Rate SDRAM (DDR SDRAM), an Enhanced SDRAM (ESDRAM), a Synchlink DRAM (SLDRAM), and a Direct Rambus RAM (DR RAM). It should be noted that the memory of the systems and methods described herein is intended to include but not be limited to these and any other suitable types of memories.

It should be understood that the memory or the computer storage medium described above is exemplary but not limiting. For example, the memory in embodiments of the present disclosure may also be a SRAM, a DRAM, a SDRAM, a DDR SDRAM, an ESDRAM, an SLDRAM, a DR RAM, or the like. That is, the memory in embodiments of the present disclosure is intended to include but not be limited to these and any other suitable types of memories.

Those of ordinary skill in the art would appreciate that the various exemplary units and algorithm operations described in connection with the embodiments in the present disclosure can be implemented in electronic hardware or a combination of computer software and electronic hardware. Whether these functions are performed in hardware or software depends on the specific application and design constraints of the technical solutions. Those of ordinary skill may use different methods for each particular application to implement the described functionality, but such implementation should not be considered outside the scope of the present disclosure.

Those skilled in the art would clearly appreciate that for the specific operating processes of the above-described systems, devices and units, the references may be made to the corresponding processes in the aforementioned method embodiments and would not be repeated herein, for convenience and brevity of description.

In several embodiments provided in the present disclosure, it should be understood that the disclosed systems, devices and methods may be implemented in other ways. For example, the above-described embodiments of the devices are only schematic, for example, the division of the unit is only a logical function division, and in practice, there may be another division method, for example, multiple units or components may be combined or integrated into another system, or some features may be ignored or not performed.

Furthermore, the coupling or direct coupling or communication connection between each other illustrated or discussed may be indirect coupling or communication connection through some interface, device or unit, and may be electrical, mechanical or other forms.

The units illustrated as separate components may or may not be physically separated, and the components displayed as unit may or may not be physical units, that is, the units and the components may be located in one place, or may be distributed over multiple network units. Part or all of the units can be selected according to the actual needs to achieve the purpose of the embodiments.

In addition, various functional units in the embodiments of the present disclosure may be integrated in one processing unit, or various units may exist physically alone, or two or more units may be integrated in one unit.

In any one of the embodiments of the disclosure, a time interval, a time period, within a time range, within a time duration, or within a time window, or the like may include both the endpoint times, or may include part of the endpoint times (for example, including the left endpoint time but not including the right endpoint time, or including the right endpoint time but not including the left endpoint time), or may not include the endpoint times.

The functions may be stored in a computer readable storage medium if implemented in the form of software functional units and sold or used as stand-alone products. In view of this understanding, the technical solutions of the present disclosure in essence, or the part that contributes to the related art, or the part of the technical solutions can be embodied in the form of a software product. The computer software product is stored in a storage medium and includes instructions that enables a computer device (which may be a personal computer, server, network device, or the like) to perform all or part of the operations of the methods described in various embodiments of the present disclosure. The aforementioned storage medium includes a USB flash disk, a removable hard disk, a ROM, a RAM, a magnetic disk or an optical disk and other medium capable of storing program codes.

The above-mentioned is only the specific implementation of the present disclosure, but the scope of protection of the present disclosure is not limited thereto. Any variation or substitution readily conceivable by those skilled in the art within the scope of the technology disclosed in the present disclosure shall be covered by the scope of protection of the present disclosure. Therefore, the scope of protection of the present disclosure should be subject to the scope of protection of the claims.

1. A communication method, comprising:
handing over, by a terminal device, from a source cell to a target cell, wherein the target cell is determined based on a target Artificial Intelligence (AI) model and target input information for input into the target AI model.

2. The communication method of claim 1, wherein the target input information comprises first input information and/or second input information, and the method further comprises:
receiving, by the terminal device, the first input information transmitted by a first network device corresponding to the source cell, and/or determining, by the terminal device, the second input information of the terminal device;
determining, by the terminal device, a first cell based on the target AI model, and the first input information and/or the second input information; and
determining, by the terminal device, the target cell based on the first cell.

3. The communication method of claim 2, wherein determining, by the terminal device, the target cell based on the first cell comprises:
transmitting, by the terminal device, indication information to the first network device, wherein the indication information is carried in a measurement report and is used to indicate the first cell; and
receiving, by the terminal device, a handover command transmitted by the first network device, wherein the handover command is used to indicate the target cell, and the target cell is the first cell or a second cell.

4. The communication method of claim 2, wherein determining, by the terminal device, the target cell based on the first cell comprises:
determining, by the terminal device, that the first cell is the target cell; or
determining, by the terminal device, the target cell based on the first cell and a measurement result.

5. The communication method of claim 4, wherein the measurement result comprises a measurement value of the first cell;
wherein determining, by the terminal device, the target cell based on the first cell and the measurement result comprises:
in a case that the measurement value of the first cell is greater than a preset threshold, determining, by the terminal device, that the first cell is the target cell; and/or
in a case that the measurement value of the first cell is less than or equal to the preset threshold, determining, by the terminal device, a cell whose measurement value is greater than the preset threshold in the measurement result as a second cell, and determining, by the terminal device, that the second cell is the target cell.

6. The communication method of claim 1, further comprising:
receiving, by the terminal device, pre-configuration information transmitted by a first network device corresponding to the source cell, wherein the pre-configuration information comprises at least one candidate cell, and the at least one candidate cell comprises the target cell.

7. The communication method of claim 2, wherein the first input information comprises at least one of: cell information of the source cell, load information of the source cell, service type information supported by the source cell, or a measurement result of an uplink reference signal corresponding to the source cell; and
the second input information comprises at least one of: a measurement result of the terminal device, location information of the terminal device, movement trajectory information of the terminal device, movement speed information of the terminal device, navigation information of the terminal device, or service requirement information of the terminal device.

8. A terminal device, comprising:
a processor; and
a memory for storing a computer program that, when executed by the processor, causes the terminal device to hand over from a source cell to a target cell, wherein the target cell is determined based on a target Artificial Intelligence (AI) model and target input information for input into the target AI model.

9. The terminal device of claim 8, wherein the target input information comprises first input information and/or second input information, the target AI model comprises a first AI model and a second AI model, and the terminal device further comprises a transceiver, wherein the processor is configured to execute the computer program to cause the terminal device to:
receive, through the transceiver, first intermediate information transmitted by a first network device corresponding to the source cell, wherein the first intermediate information is determined based on the first AI model, and the first input information and/or the second input information;
determine a first cell based on the second AI model and the first intermediate information; and
determine the target cell based on the first cell.

10. The terminal device of claim 9, wherein the processor is configured to execute the computer program to cause the terminal device to:
transmit, through the transceiver, indication information to the first network device, wherein the indication information is carried in a measurement report and is used to indicate the first cell; and
receive, through the transceiver, a handover command transmitted by the first network device, wherein the handover command is used to indicate the target cell, and the target cell is the first cell or a second cell.

11. The terminal device of claim 9, wherein the processor is configured to execute the computer program to cause the terminal device to:
determine that the first cell is the target cell; or
determine the target cell based on the first cell and a measurement result.

12. The terminal device of claim 11, wherein the measurement result comprises a measurement value of the first cell, and
wherein the processor is configured to execute the computer program to cause the terminal device to:
in a case that the measurement value of the first cell is greater than a preset threshold, determine that the first cell is the target cell; and/or
in a case that the measurement value of the first cell is less than or equal to the preset threshold, determine a cell whose measurement value is greater than the preset threshold in the measurement result as a second cell, and determine that the second cell is the target cell.

13. The terminal device of claim 8, wherein the target input information comprises first input information and/or second input information, and the terminal device further comprises a transceiver,
wherein the processor is configured to execute the computer program to cause the terminal device to receive, through the transceiver, a handover command transmitted by a first network device corresponding to the source cell, wherein the handover command is used to indicate the target cell, and the target cell is a first cell or a second cell,
wherein the first cell is determined based on the target AI model, and the first input information and/or the second input information;
the first input information is determined by the first network device; and
the second input information is transmitted by the terminal device to the first network device.

14. The terminal device of claim 8, wherein the target input information comprises first input information and/or second input information, the target AI model comprises a third AI model and a fourth AI model, and the terminal device further comprises a transceiver,
wherein the processor is configured to execute the computer program to cause the terminal device to:
receive, through the transceiver, the first input information transmitted by a first network device corresponding to the source cell, and/or determine the second input information of the terminal device;
determine second intermediate information based on the third AI model, and the first input information and/or the second input information;
transmit, through the transceiver, the second intermediate information to the first network device, wherein the second intermediate information is used to determine a first cell in conjunction with the fourth AI model; and
receive, through the transceiver, a handover command transmitted by the first network device, wherein the handover command is used to indicate the target cell, and the target cell is the first cell or a second cell.

15. The terminal device of claim 10, wherein the processor is configured to execute the computer program to cause the terminal device to:
transmit a measurement result to the first network device through the transceiver, wherein the measurement result is used to determine the target cell in conjunction with the first cell.

16. A network device, comprising:
a processor; and
a memory for storing a computer program that, when executed by the processor, causes the network device to perform handover of at least one terminal device from a source cell to a target cell, wherein the target cell is determined based on a target Artificial Intelligence (AI) model and target input information for input into the target AI model.

17. The network device of claim 16, wherein the target input information comprises first input information, or the target input information comprises the first input information and second input information; and the network device further comprises a transceiver,
wherein the processor is configured to execute the computer program to cause the network device to transmit, through the transceiver, the first input information to the terminal device, wherein the first input information is used to determine the target cell in conjunction with the target AI model, or the first input information is used to determine the target cell in conjunction with the target AI model and the second input information.

18. The network device of claim 16, wherein the target input information comprises first input information and/or second input information, the target AI model comprises a first AI model and a second AI model, and the network device further comprises a transceiver,
wherein the processor is configured to execute the computer program to cause the network device to:
determine first intermediate information based on the first AI model, and the first input information and/or the second input information; and
transmit, through the transceiver, the first intermediate information to the terminal device,
wherein the first intermediate information is used to determine the target cell in conjunction with the second AI model.

19. The network device of claim 17, wherein the processor is configured to execute the computer program to cause the network device to:
receive, through the transceiver, indication information transmitted by the terminal device, wherein the indication information is carried in a measurement report and is used to indicate a first cell, and wherein the first cell is determined based on the target AI model, and the first input information and/or the second input information, or the first cell is determined based on a second AI model and first intermediate information;
determine the target cell based on the first cell, wherein the target cell is the first cell or a second cell; and
transmit, through the transceiver, a handover command to the terminal device, wherein the handover command is used to indicate the target cell.

20. The network device of claim 16, wherein the target input information comprises first input information and/or second input information, and the network device further comprises a transceiver,
wherein the processor is configured to execute the computer program to cause the network device to:
determine the first input information of the network device, and/or receive, through the transceiver, the second input information transmitted by the terminal device;
determine the target cell based on the target AI model, and the first input information and/or the second input information, wherein the target cell is a first cell or a second cell; and
transmit, through the transceiver, a handover command to the terminal device, wherein the handover command is used to indicate the target cell.
